(19) United States
(12) Patent Application Publication
(10) Pub. No.: US 2011/0168880 A1
(43) Pub. Date: Jul. 14, 2011

(54) TIME-OF-FLIGHT MASS SPECTROMETER WITH CURVED ION MIRRORS

(75) Inventors: Trygve RISTROPH, Fremont, CA (US); Curt Alan FLORY, Los Altos, CA (US)

(73) Assignee: AGILENT TECHNOLOGIES, INC., Loveland, CO (US)

(21) Appl. No.: 12/686,720

(22) Filed: Jan. 13, 2010

(51) Int. Cl. H01J 49/26

(52) U.S. Cl. 250/282; 250/287

(57) ABSTRACT

A mass spectrometer includes: an accelerator for receiving ions travelling in a drift direction and accelerating the ions in an acceleration direction orthogonal to the drift direction; a detector downstream of the accelerator with respect to the drift direction; and an ion mirror assembly intermediate the accelerator and the detector. The ion mirror assembly includes at least a first ion mirror and a second ion mirror spaced apart from each other in the acceleration direction. The accelerator, detector, and ion mirror assembly provide a folded ion path between the accelerator and the detector for separating the ions according to their mass-to-charge ratio so that a flight time of the ions is substantially independent of ion energy. The first and second ion mirrors each apply an electrostatic potential to the ions that is curved in both the drift direction and a lateral direction orthogonal to both the drift and acceleration directions.

### BACKGROUND

High resolution mass spectrometry is used to determine the chemical composition of substances by accurately measuring the masses of the ions composing the unknown material.

Time-of-flight mass spectrometry (TOFMS) is a method of mass spectrometry in which ions are accelerated by an electric field of known strength. This acceleration results in an ion having the same kinetic energy as any other ion that has the same charge. The velocity of the ion depends on the mass-to-charge ratio. For electrostatic systems, all ions of identical kinetic energy and initial coordinates travel along the same beam path and separate by mass-to-charge ratio along the direction of travel only. The time that it subsequently takes for the particle to reach a detector at a known distance is measured. Ideally, an ion's time-of-flight, designated as T, is a function of only the ion mass-to-charge ratio and properties of the mass spectrometer electrostatic potential. From this time-of-flight, T, and the known experimental parameters, one can find the mass-to-charge ratio of the ion.

Most time-of-flight systems use a technique known as orthogonal acceleration to introduce the ions into the flight path. FIG. 1 illustrates an example of a time-of-flight mass spectrometer (TOFMS) 100 that employs orthogonal acceleration. TOFMS 100 includes an ion source 112, an ion transport 113, an isolation valve 115, repeller plates 114, grids 116, reflectron 117, flight tube 118 and detector 120. Repeller plates 114 and grids 116 together constitute an ion accelerator 122.

In operation, a slow low-energy ion beam drifts into ion accelerator 122 along the “X” direction (hereinafter referred to as “the drift direction”) when no electric fields are present. The start time of the measurement is defined by the application of a high voltage acceleration pulse to accelerator 122 which provides a force on the ions directed in a “Y” direction (hereinafter referred to as “the longitudinal direction” and also sometimes called “the acceleration direction”), which is orthogonal to the drift direction. The accelerated ion beam emerges from the accelerator at a small angle to the acceleration direction, known as the natural angle, which is the resultant of the initial drift velocity and the additional velocity in the acceleration direction. Typically the natural angle is between 2 and 4 degrees. Because the acceleration is orthogonal to the initial beam propagation, the velocity component in the drift direction is conserved. The ions also have initial displacements and velocities in the “Z” direction (hereinafter referred to as “the lateral direction”) that extends into and out of the plane of the drawing sheet for FIG. 1 (shown in FIG. 1 as a “”).

It is important to carefully distinguish between the drift direction, acceleration direction, and lateral direction with respect to the flight path of the ions in the discussion to follow. Accordingly, various drawings in this disclosure, including FIG. 1, are labeled with a set of X, Y, and Z axes that consistently indicate the drift direction, the acceleration direction, and the lateral direction, respectively.

In the idealized situation, the ion's starting position and starting velocity within the accelerator, i.e. its initial conditions, have negligible influence on the time-of-flight. Since neither the ion's initial position nor its velocity is a quantity of interest, any functional dependence of T on these parameters degrades the quality of the measurement. In reality, absolute and total independence of T from initial ion conditions is physically impossible to realize. An ion with a particular initial position and velocity will have a time-of-flight which in general is different in value from the time-of-flight of another ion of equal mass and charge, but which starts with a different set of initial conditions. Any real ion beam, and specifically the beam going into the ion accelerator, has a non-zero spatial extent and likewise also has a random variation in velocity over some non-zero range. The non-zero widths of the distribution of possible initial conditions results in a distribution of ion flight times, or peak spreading, for ions of equal mass and charge. This finite peak width hinders one's ability to resolve chemically distinct species that may have nearly identical, but not equal, mass-to-charge ratios. Quantitatively, this peak broadening is a degradation of resolving power, an important performance metric of any mass spectrometer.

A crucial design goal of high resolution time-of-flight mass spectrometry is to engineer an arrangement of electrodes which, when charged to an optimum set of static voltages, create an electrostatic field such that the time-of-flight T has the weakest possible functional dependence on an ion's initial conditions within the accelerator. Realization of this goal is known as aberration correction or compensation. A well-compensated time-of-flight mass spectrometer is able to detect small quantities of an unknown analyte while maintaining high mass resolution. Concurrent improvements to both analyte sensitivity and mass resolution are made possible by engineering the electrostatic potential such that ions having equal mass and charge, but having wide ranges of initial conditions, arrive at the detector simultaneously.

In three dimensions, an ion's trajectory and its time-of-flight are completely determined by the electrostatic field and the six independent parameters which together specify the ion's initial position and initial velocity. An ion trajectory originating at the center of the initial ion distribution is referred to as the optical ray or axial trajectory. Other ions which deviate from the optical ray and degrade mass resolution are said to be deviant. All of the six possible deviations from the optical ray's starting point cause time-of-flight aberrations. Historically, the most important aberrations are caused by the two possible deviations in the acceleration direction. The acceleration direction velocity spread causes a peak spreading of mass peaks known as turn-around time which does not grow as the ion packet travels through the flight path. Position spread along the acceleration axis creates an ion energy spread that also spreads the mass peaks, but in a manner which is dependent upon the electrostatic field within the mass spectrometer. The four possible deviations in the plane orthogonal to the acceleration direction are called transverse deviations. While minimization of the longitudinal aberrations has been extensively studied in prior-art, transverse aberration compensation has not been explored to the same level of detail.

The mass resolution of time-of-flight instruments scales linearly with the total distance of the ion flight path and consequently extending this length is important for high resolution instruments. Transverse focusing becomes increasingly important as the path length is extended for three reasons. First and most simply, transverse velocity spread causes the ion beam to diverge as it travels along the flight path. A long flight path means the beam can grow to impractically large transverse widths unless transverse focusing continuously bends deviant trajectories back towards the optical ray, guiding the beam as it travels. The second and third reasons for transverse focusing specifically apply to multi-reflection time-of-flight systems, where the flight path is folded up using ion mirrors in order to maintain a practical instrument size. Mass misidentification occurs whenever the beam's transverse width exceeds the spacing between adjacent reflection points, which causes trajectories experiencing a different number of reflections to overlap at the detector. Last, the ion mirrors used in multi-reflection instruments typically do not have meshes or grids often used to define a uniform electric field in the mirror. The number of remaining ions goes down exponentially with the number of grid passes and even when ultra fine wires are used and grid transmissions are on the order of 90% it is nearly impossible to maintain a detectable ion signal after several reflections. Without grids, the fundamental equation for the electrostatic potential, Laplace's equation, enforces a fundamental limitation: a mirror's electrostatic potential generates transverse electric fields in addition to longitudinal reflecting fields. The transverse fields will either focus or de-focus the ion beam. Since transverse forces will inevitably be present, an optimal mass spectrometer design will take advantage of them to realize the needed beam guiding while introducing minimal time-of-flight aberrations.

Transverse focusing may be realized in an ion-mirror, known as reflective focusing, or in a lens which will be referred to as transmissive focusing. Each of these transverse focusing methods introduces time-aberrations which depend on the trajectory of the ions through the mirror or lens. As will be discussed below, reflective and transmissive focusing introduce time-aberrations which are inherently different from one another, even when both methods give the same spatial focal distance. Ideally these aberrations will be minimized and initial transverse position and velocity will have minimal effect on the time-of-flight.

Hermann Wollnik GB2080021 (“Wollnik”) disclosed using ion mirrors and intermediate lenses in the flight path for transverse focusing in multi-reflecting time-of-flight instruments.

FIG. 2 shows an embodiment of a multi-reflecting time-of-flight mass spectrometer (MR-TOFMS) disclosed by Wollnik (FIG. 3 of Wollnik patent) that uses only focusing mirrors. In FIG. 2, ions of different masses and energies are emitted by a source 12. The flight path of ions to a collector 20 is folded by arranging for multiple reflections of the ions by mirrors R1, R2, . . . R7. The mirrors are arranged such that the ion flight time is substantially independent of ion energy. Note that the ions travel at an angle to optical axis of ion mirrors which induces additional time-of-flight aberrations and thus considerably complicates achieving high resolution

Subsequent to Wollnik, several additional embodiments have been disclosed.

Nazarenko et al. SU1725289 (“Nazarenko”), discloses a time-of-flight mass spectrometer with a zig-zag flight path defined by two planar mirrors, built of bars, which are parallel and symmetric with respect to the median plane between the mirrors and also to the plane of the folded ion path. FIG. 3 shows an embodiment of Nazarenko's device. As shown in FIG. 3, one mirror includes three electrodes 3, 4 and 5, and the other mirror includes electrodes 6, 7 and 8. Each electrode is made of a pair of parallel plates ‘a’ and ‘b’, symmetric with respect to the ‘central’ plane XY. An ion source 1 and detector 2 are located in the drift space between the ion mirrors. The mirrors provide multiple ion reflections. The number of reflections is adjusted by moving ion source 1 along the X-axis (drift direction) relative to detector 2. Nazarenko describes a type of ion focusing which is achieved on every ion turn, achieving a spatial ion focusing in the Z (lateral) direction and a second order time of flight focusing with respect to ion energy. Nazarenko provides no ion focusing in the drift direction, thus essentially limiting the number of reflection cycles.

More recently, Verentchikov et al (U.S. Pat. No. 7,385,187) discloses an instrument with reflective refocusing in the lateral direction, and drift-direction transmissive refocusing. FIGS. 4A-B illustrate an embodiment, including a pulsed ion source 12 with a built in accelerator 13, an ion detector 16, a set of two gridless ion mirrors 15, parallel to each other and substantially elongated in the drift direction, denoted again as the X axis, a field-free space 14 between the mirrors and a set of multiple lenses 17, positioned in the drift space 14. The mirrors 15 each include a lens electrode 15L, two electrodes 15E and a cap electrode 15C. FIG. 4B shows a side view of the device shown in FIG. 4A. The above elements are arranged to provide a folded ion path 19 between the ion source 12 and the ion detector 16, the ion path being determined by of multiple reflections between the ion mirrors 15 and an ion drift in the drift (X) direction. Lenses 17 are positioned in the drift (X) direction with a period determined by the ion drift distance between reflections, providing periodic focusing in the drift (X) direction, complementing a periodic spatial focusing by mirrors 15 in the lateral (Z) direction.

Ioanoviciu et al., 40 Journal of Mass Spectrometry 1626-27 (2005) discloses gridded curved mirrors for single reflection systems with reflective focusing along one direction only. FIG. 5 illustrates Ioanoviciu's arrangement.

Reflective focusing in the drift direction is inherently more technically challenging than lateral reflective focusing. In the case of lateral focusing, all forces are symmetric about the axial ray and all odd order aberrations vanish. It is difficult to realize this symmetry in the drift direction and simultaneously allow the beam to undergo specular reflection from the mirror. Despite the difficulty, the implementation of reflective drift-direction focusing is an important problem to solve because of the potential advantages of reduced time-of-flight aberrations and instrument simplification.

What is needed, therefore, is a time-of-flight mass spectrometer that provides simultaneous lateral and drift-direction focusing.

### SUMMARY

In an example embodiment, a multi-reflecting time-of-flight mass spectrometer (MR-TOFMS) comprises: an ion accelerator adapted to receive ions travelling in a drift direction and to accelerate the ions in an acceleration direction orthogonal to the drift direction; an ion detector downstream of the ion accelerator with respect to the drift direction; and an ion mirror assembly intermediate the ion accelerator and the ion detector, the ion mirror assembly comprising at least a first ion mirror and a second ion mirror spaced apart from each another in the acceleration direction, wherein the ion accelerator, ion detector, and ion mirror assembly are arranged to provide a folded ion path between the ion accelerator and the ion receiver for separating the ions in time of arrival according to their mass-to-charge ratio so that a flight time of the ions is substantially independent of ion energy, and wherein the first and second ion mirrors each apply a curved electrostatic potential to the ions in both the drift direction and a lateral direction orthogonal to both the drift direction and the acceleration direction.

In another example embodiment, a multi-reflecting time-of-flight mass spectrometer (MR-TOFMS) comprises: an ion accelerator adapted to receive ions travelling in a drift direction and to accelerate the ions in an acceleration direction orthogonal to the drift direction; an ion detector downstream of the ion accelerator with respect to the drift direction; an ion mirror assembly intermediate the ion accelerator and the ion detector, the ion mirror assembly comprising at least a first ion mirror and a second ion mirror spaced apart from each another in the acceleration direction; and an ion lens assembly intermediate the first and second ion mirrors, wherein the ion accelerator, ion detector, ion lens assembly, and ion mirror assembly are arranged to provide a folded ion path between the ion accelerator and the ion detector for separating the ions in time of arrival according to their mass-to-charge ratio so that a flight time of the ions is substantially independent of ion energy, and wherein the first and second ion mirrors each apply a curved electrostatic potential to the ions in both the drift direction and a lateral direction orthogonal to both the drift direction and the acceleration direction, and wherein voltages are applied to the ion mirror assembly and the ion lens assembly to compensate, either partially or fully, a second order time aberration with respect to drift direction deviation among the ions.

In yet another example embodiment, a method is provided of multi-reflecting time-of-flight mass spectrometry. The method includes: receiving ions travelling in a drift direction and accelerating the ions in an acceleration direction orthogonal to the drift direction; providing a folded ion path between the ion accelerator and the ion receiver for separating the ions in time of arrival according to their mass-to-charge ratio so that a flight time of the ions is substantially independent of ion energy; and detecting a time of arrival of the ions at a detector downstream of the ion accelerator with respect to the drift direction, wherein providing the folded ion path includes reflecting the ions from first and second ion mirrors, each of the first and second ion mirrors applying a curved electrostatic potential to the ions in both the drift direction and a lateral direction orthogonal to both the drift direction and the acceleration direction.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 illustrates an example of a time-of-flight mass spectrometer (TOFMS).

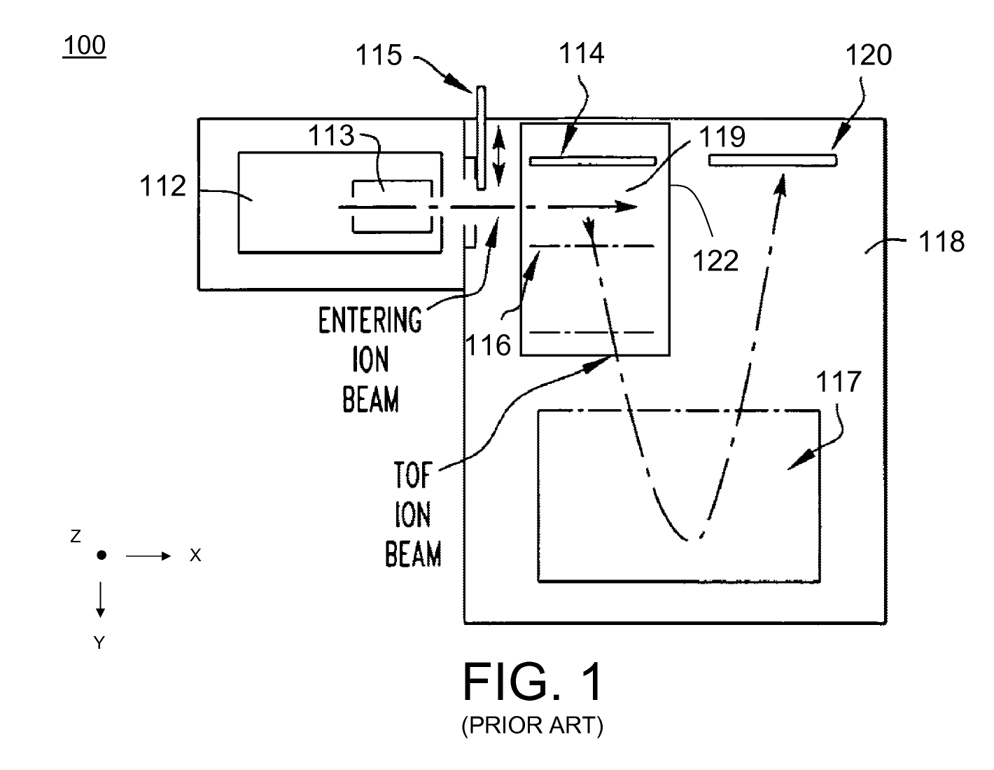

FIG. 2 shows an example of a multi-reflecting time-of-flight mass spectrometer (MR-TOFMS).

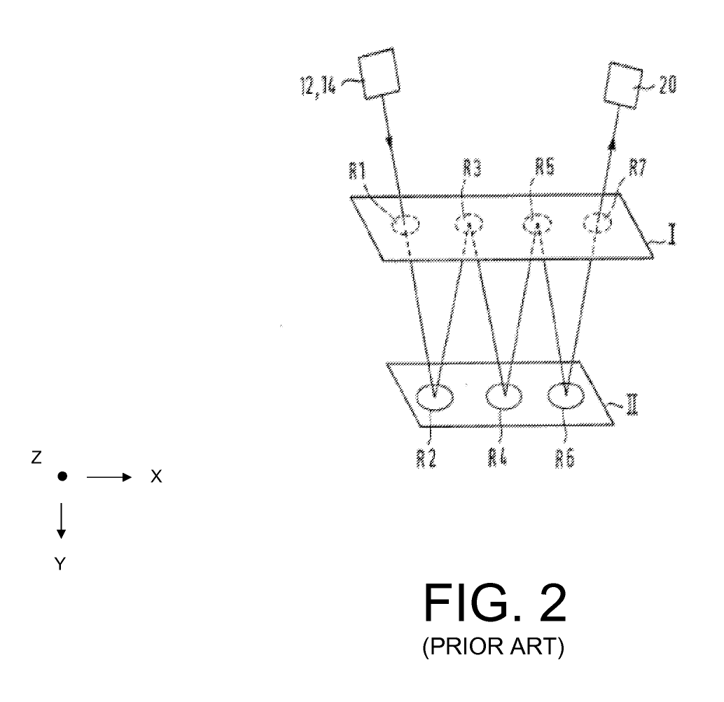

FIG. 3 illustrates another example of a multi-reflecting time-of-flight mass spectrometer (MR-TOFMS).

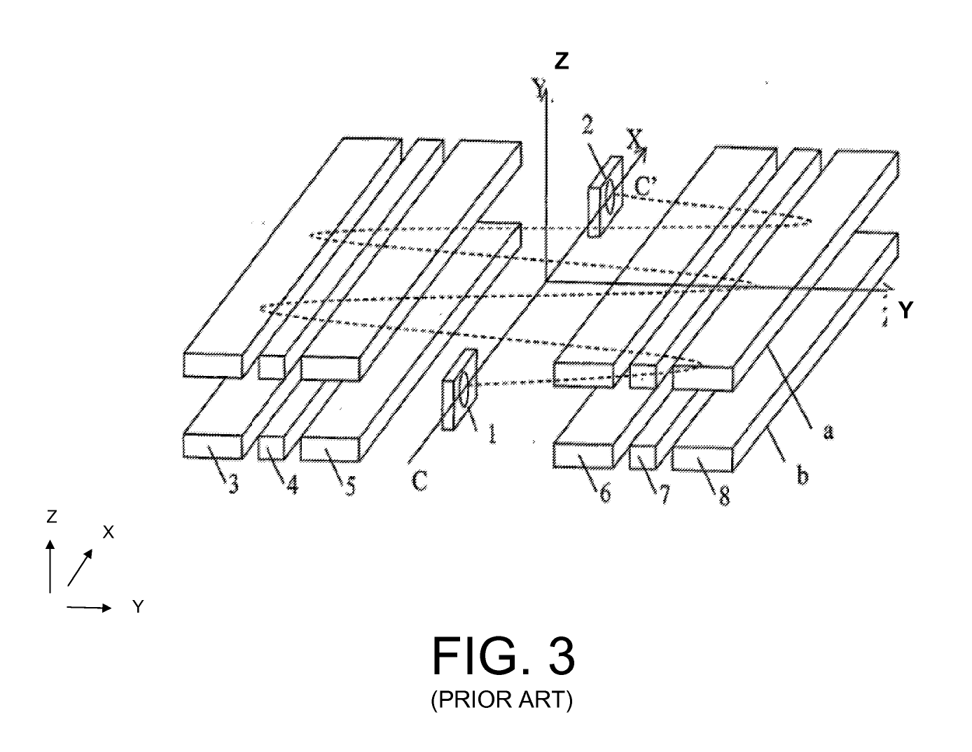

FIGS. 4A-B show yet another example of a multi-reflecting time-of-flight mass spectrometer (MR-TOFMS).

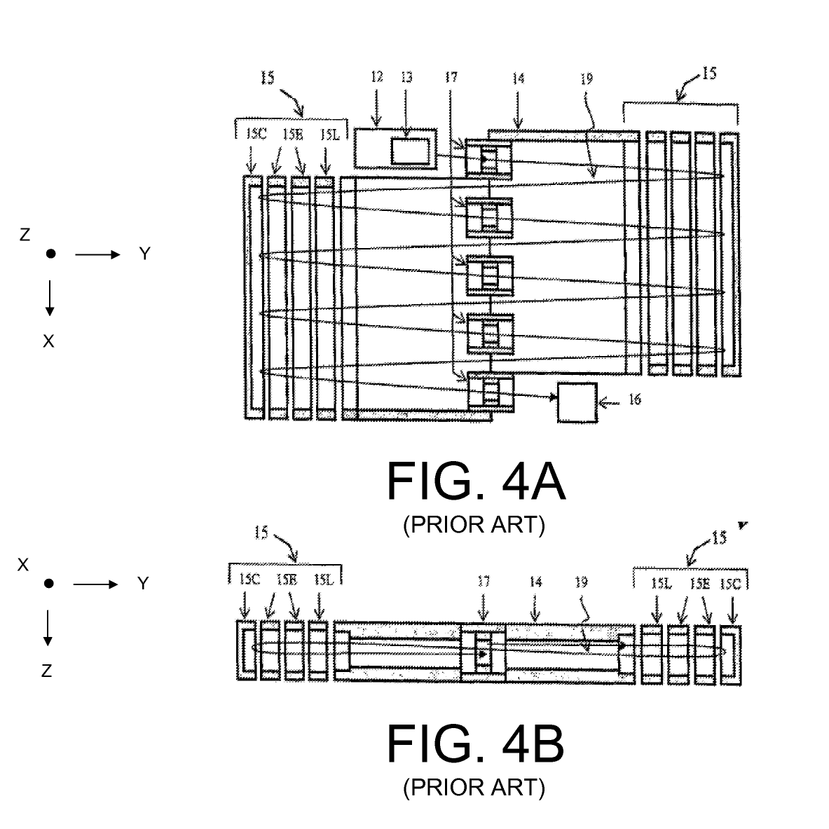

FIG. 5 illustrates a gridded mirror that is curved in only one direction.

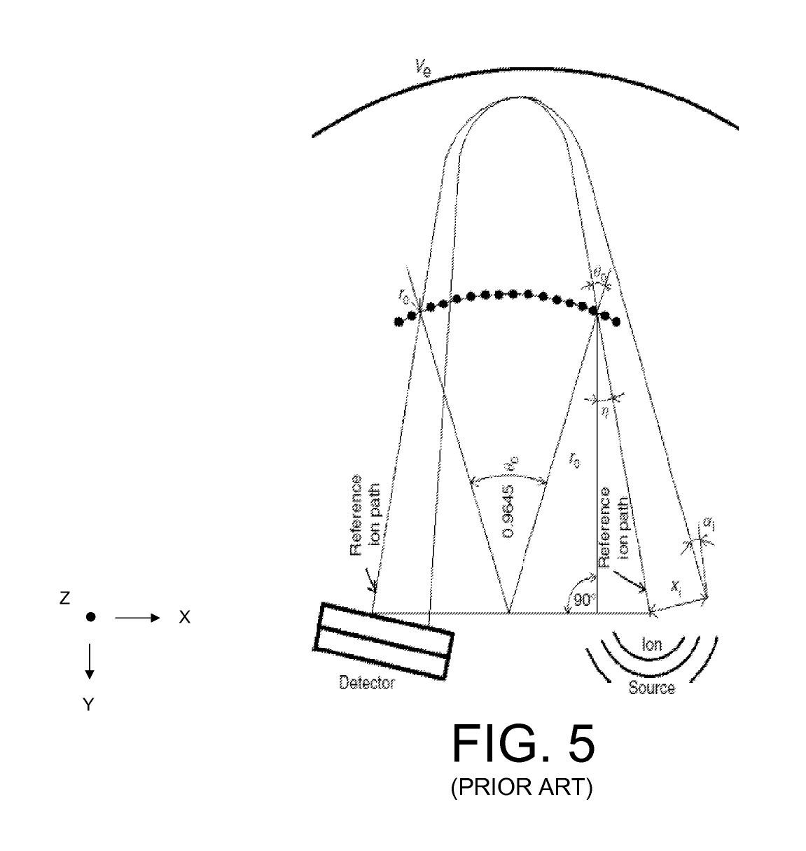

FIG. 6 illustrates an Einzel lens.

FIG. 7 illustrates a cylindrical mirror.

FIG. 8 illustrates one embodiment of a multi-reflecting time-of-flight mass spectrometer (MR-TOFMS).

FIG. 9 illustrates a cross-section of one embodiment of a mirror unit cell of one embodiment of a curved ion mirror.

FIG. 10 illustrates isopotential lines of a mirror potential at a cross-sectional plane of one embodiment of a curved ion mirror.

FIG. 11 illustrates another embodiment of a multi-reflecting time-of-flight mass spectrometer (MR-TOFMS).

FIG. 12 shows a three dimensional view of the multi-reflecting time-of-flight mass spectrometer (MR-TOFMS) of FIG. 11.

FIG. 13 illustrates an example beam front of an ion beam at a detector for the MR-TOFMS of FIG. 11 under a first voltage level at the lens assembly.

FIG. 14 illustrates an example beam front of an ion beam at a detector for the MR-TOFMS of FIG. 11 under a second voltage level at the lens assembly.

FIG. 15 illustrates an example beam front of an ion beam at a detector for the MR-TOFMS of FIG. 11 under a third voltage level at the lens assembly.

FIG. 16 illustrates one embodiment of a mirror unit cell for one embodiment of a curved ion mirror.

FIG. 17 illustrates another example embodiment of a curved ion mirror.

FIG. 18 illustrates several example embodiments of a backplate electrode for a curved ion mirror.

### DETAILED DESCRIPTION

In the following detailed description, for purposes of explanation and not limitation, example embodiments disclosing specific details are set forth in order to provide a thorough understanding of an embodiment according to the present teachings. However, it will be apparent to one having ordinary skill in the art having had the benefit of the present disclosure that other embodiments according to the present teachings that depart from the specific details disclosed herein remain within the scope of the appended claims. As used herein, “approximately” means within 10%, and “substantially” means at least 75%. In this disclosure, when a surface, whether it be a structural surface or an isopotential surface, is said to be “curved” it means that the surface is non-planar. Beneficially, some embodiments of curved surfaces as described herein have a finite radius of curvature.

Disclosed below is a time-of-flight mass spectrometer with one or more ion mirror electrode structures designed to create a concave electrostatic potential capable of focusing ions in both the drift and lateral directions. The term concave is used here with reference to the ions location, meaning that a deviant ion reaches a given potential value before the axial ray whenever the axial ray lies along a radius vector. In its simplest embodiment, the electrodes are curved along concentric arcs to create similarly concave isopotential surfaces within the mirror structure. In other embodiments, only some of the electrodes are curved and in other embodiments none of the electrodes are curved but additional electrodes are provided for the specific purpose of creating a concave isopotential surface. In various embodiments described below, the concave isopotential surfaces create transverse electric fields which generate transverse forces on the ions in the drift direction which focus them towards the axial ray.

Electrostatic focusing of charged particles is most commonly applied to achieving high spatial resolution in electron microscopy (see, e.g., Geometrical Charged-Particle Optics, Harald H. Rose, Springer Series in Optical Sciences). Reflective focusing is fundamentally different than transmissive focusing with respect to chromatic and spherical aberrations, both of which degrade imaging resolution (see, e.g., G. F. Rempfer, 67 JOURNAL OF APPLIED PHYSICS No. 10, 15 May 1990). For example, the Scherzer theorem states that transmissive focusing elements will always have a first order chromatic aberration in spatial focal length. Similarly, cylindrical and planar Einzel lenses always have a positive spherical aberration coefficient, meaning more deviant trajectories are over focused, i.e. they are bent more than paraxial rays. Neither of these restrictions on the chromatic and spherical aberrations exists for electrostatic mirrors. Consequently, spatial focusing may be improved by introducing electrostatic mirrors into an otherwise transmissive beam path.

When considering time-of-flight aberrations, the set of fundamental physical restrictions placed upon reflective focusing is also different from its transmissive counterpart. The second order aberration in time-of-flight with respect to lateral deviation can be compensated at the spatial focal point by using an ion mirror with both transmissive and reflective focusing regions. On the contrary, purely transmissive elements always have a positive second-order lateral time-of-flight aberration, as argued below. By positive aberration, it is meant that a deviant ion is delayed in the lens relative to the axial ray.

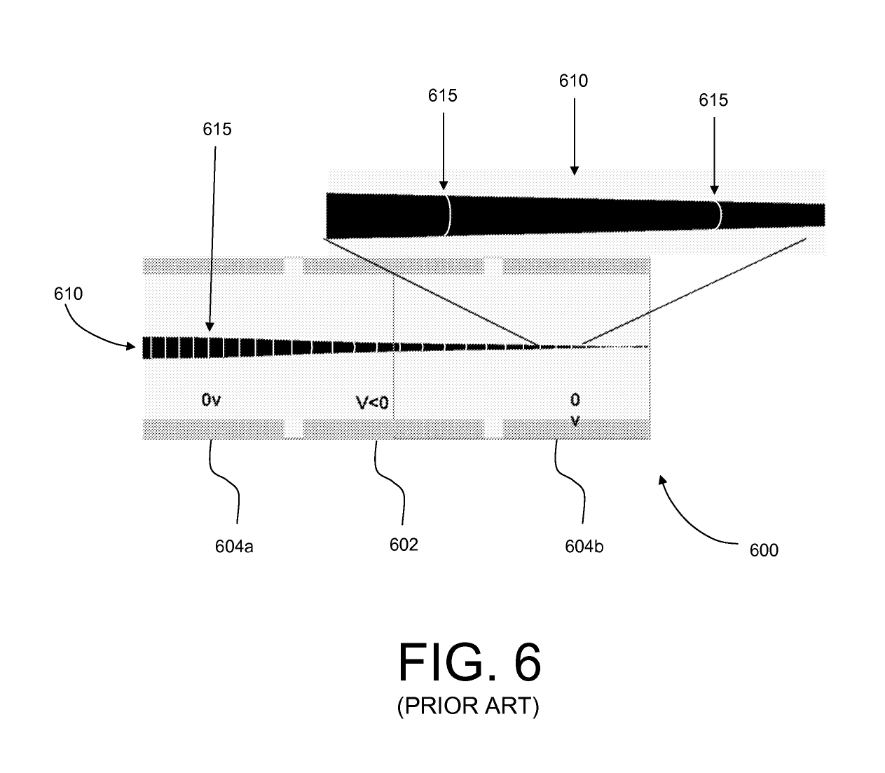

FIG. 6 illustrates an Einzel lens 600. An ion beam 610 enters from the left and is focused by passing through the Einzel lens. The inset in FIG. 6 shows a close-up of the beam front 615 and reveals the fact that deviant ions are delayed by lens 600 relative to the axial ray.

Einzel lens 600 in the paraxial approximation serves as the canonical element for transmissive transverse focusing. A collimated beam with an initially flat beam front 615 oriented orthogonal to the axis of lens symmetry will be considered and is illustrated in FIG. 6. The time-of-flight aberration caused by Einzel lens 600 is most simply visualized by considering the shape of ion beam front 615 after passing through Einzel lens 600. Outer, more deviant, rays are delayed by a time which scales as the second power of their initial displacement from the axis of symmetry. This simple fact can be proved by dividing the initial beam into many infinitesimally small individual “beamlets” along the transverse direction. In the paraxial approximation for a thin lens, each beamlet is bent by an angle such that it intersects the spatial focal point. The action of a transmissive electrostatic deflector is simple and well-understood in the small-angle approximation (see, e.g., Thomas Dresch U.S. Pat. No. 5,654,544). The linear (first order) beam front of each beamlet is rotated by an angle which is equal in magnitude and opposite in direction from the angle which the beamlet's velocity vector is rotated. From this analysis, it is straightforward to show that the time aberration of a transmissive lens is always positive and quadratic with respect to transverse deviation. In other words, all ions are delayed relative to the axial ray by an amount proportional to the square of their initial distance from the axis of symmetry. The exact magnitude of the relative delay is uniquely determined by the ion velocity and focal length of the lens, and not the length or shape of the lens elements.

If we assume that an ion detector is positioned orthogonal to the axis of the Einzel lens 600, then after the steered ions leave Einzel lens 600, they travel slightly different distances to reach the ion detector. Deviant ions travel on the hypotenuse of a right triangle whose longer leg is formed by the axial ray. The additional distance the ion travels after the lens also adds a quadratic time delay to the deviant ions by an amount which is dependent on the axial distance between Einzel lens 600 and detector. Thus the total time aberration gets worse as the beam progresses longitudinally down the path. As noted above in the Background, such a spread in delay among ions having the same charge-to-mass ratio limits the resolution of a time-of-flight mass spectrometer.

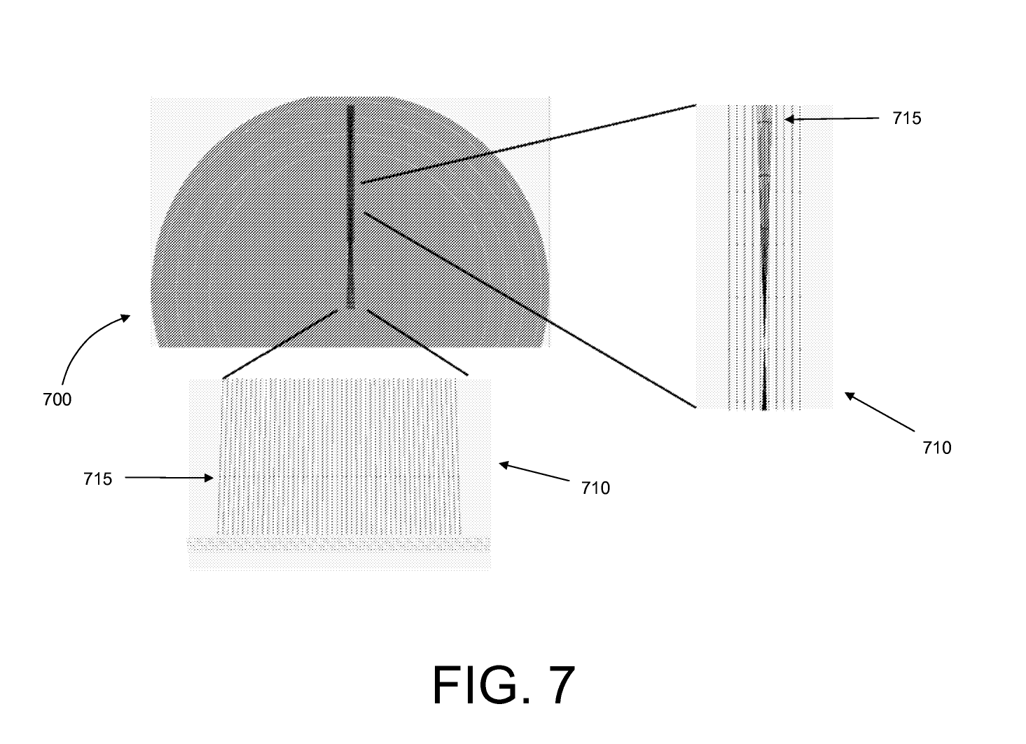

FIG. 7 illustrates transverse focusing with a cylindrical mirror 700. Initially, the collimated ion beam 710 travels straight-up and has a flat beam front 715. The right inset in FIG. 7 reveals that, after focusing by mirror 700, deviant ions in the beam front 715 are advanced in time relative to the axial ray. The lower inset in FIG. 7 shows the beam front at the longitudinal distance where the free-space time-delay cancels the mirror time-advance.

A cylindrically symmetric electrostatic potential having a concave shape serves as the canonical element for transverse focusing with a curved mirror. In this discussion, it is assumed that no forces act in the direction of the axis of rotation. As with light optics, the mirror's radius of curvature plays a major role in determining its spatial focal distance. In contrast to light optics where the rays are bent at the reflection surface only, ion trajectories are bent over a distributed distance and the mirror depth is also needed to find the focal length. The potential curvature at the back of the mirror, where ions spend more time because they are moving slower, has a greater focusing effect than the curvature elsewhere where the ions are moving faster.

Similar to an Einzel lens, a concave ion mirror also produces a time-of-flight aberration which is quadratic with respect to transverse deviation. However, the mirror time-of-flight aberration has a sign which is opposite that of its transmissive counterpart. Deviant ions emerge from the mirror sooner than the optical ray does, giving the mirror a negative quadratic time aberration. This fact is most easily seen by considering a “hard” mirror, where the rays are bent by a very steep potential. The exiting beam front resembles the curvature of the isopotential lines at the turn-around point in the mirror.

The time-advancement of deviant ions relative to the optical ray in a curved mirror leads to two ways of compensating for the transverse time-of-flight aberration.

The first method utilizes the free-space delay experienced by deviant ions after leaving the mirror to counteract, and ideally cancel, the time-advance experienced in the mirror, as illustrated in FIG. 7. For a hard-mirror, this means placing the detector at a distance equal to the spatial focal length from the mirror. For all mirrors, including realistic soft ones, there is only one detector location along the longitudinal axis for which the second order aberration coefficient is perfectly compensated.

A second means for transverse aberration compensation involves using a combination of a transmissive focusing element and a reflective focusing element. Since the sign of the aberrations are opposite for reflective and transmissive focusing, using both concurrently offers the possibility of designing a second order compensated focusing scheme. This combination of transmissive-reflective focusing is conceptually similar to the operation of an achromatic doublet used in light optics. In that case, both elements are transmissive but are made of materials with opposite signs of chromatic dispersion coefficients, chosen to cancel the effects of one another. Each material alone is dispersive, but when used together in series the combination is compensating.

The principle advantage of the transmissive-reflective doublet method of second order time-of-flight compensation is that the focusing power of the lens and mirror may be independently adjusted to locate the longitudinal position of compensation at a fixed preferred detector location. This is in contrast to the first means for second order transverse compensation which does not use a lens and has only one compensated point for a given mirror design.

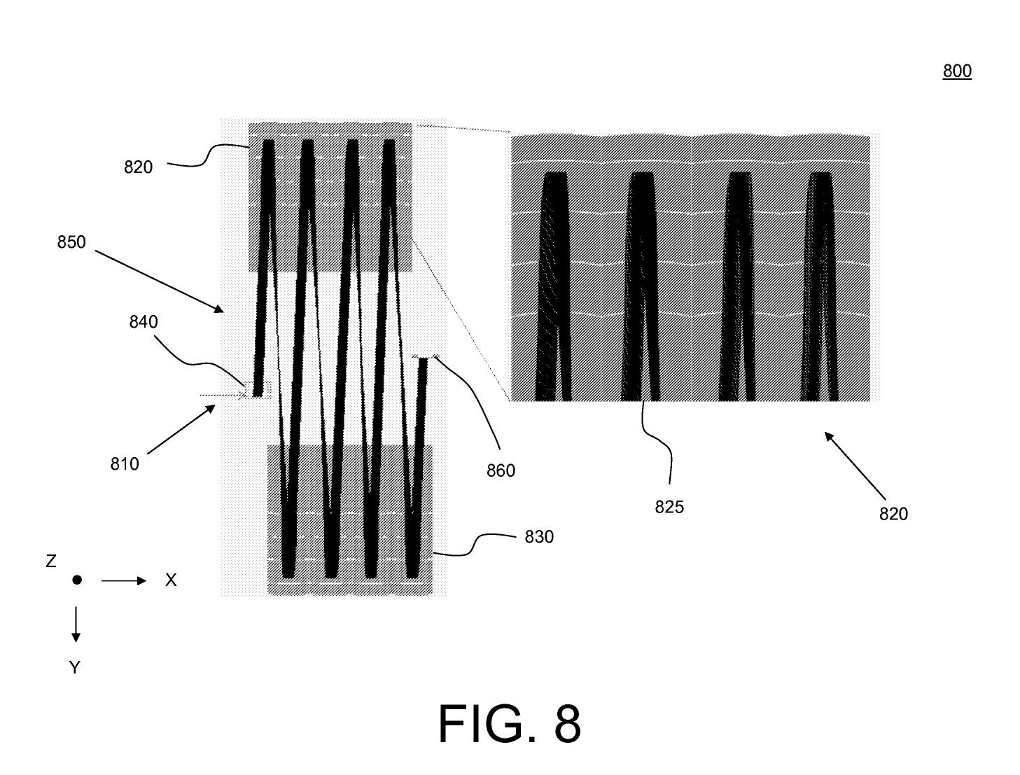

FIG. 8 shows an embodiment of a multi-reflecting time-of-flight mass spectrometer (MR-TOFMS) 800 which uses two curved ion mirrors 820 and 830 and a zig-zag multiple reflection flight path. Beneficially, curved ion mirrors 820 and 830 are gridless mirrors. In operation, a low energy ion beam 810 enters from the left along the drift (X) direction and drifts into ion accelerator 840. Upon application of a high voltage pulse, ions travel predominantly towards mirror 820 with a slight angle (the natural angle) from the acceleration (Y) direction. After multiple (e.g., eight) reflections through drift space 850, the ions reach an ion detector, or ion receiver, 860 at the right.

The inset in FIG. 8 shows a close-up of curved ion mirror 820 illustrating that it comprises multiple (e.g., four) curved sections 825. Curved ion mirror 830 is constructed similarly to curved ion mirror 820 and also includes four curved sections. Transverse focusing in the drift (X) direction is evident by the focal points at the mid-plane of the structure.

Section 825 of curved mirror 820 is periodically repeated several times, once for each reflection apex. The repeated section 825 of the mirror electrodes and accompanying electrostatic potential will hereinafter be referred to as a “mirror unit cell.” The electrostatic potential can be solved once within a mirror unit cell 825 and then repeated as many times as necessary at the desired locations. Dimensions of mirror unit cell 825 in the drift (X) and acceleration (Y) directions, and the natural angle, are chosen so that the ions reflect symmetrically about the center of mirror unit cell 825. This choice of physical dimensions ensures that the beam reflections are periodic, a simplification but not a necessity.

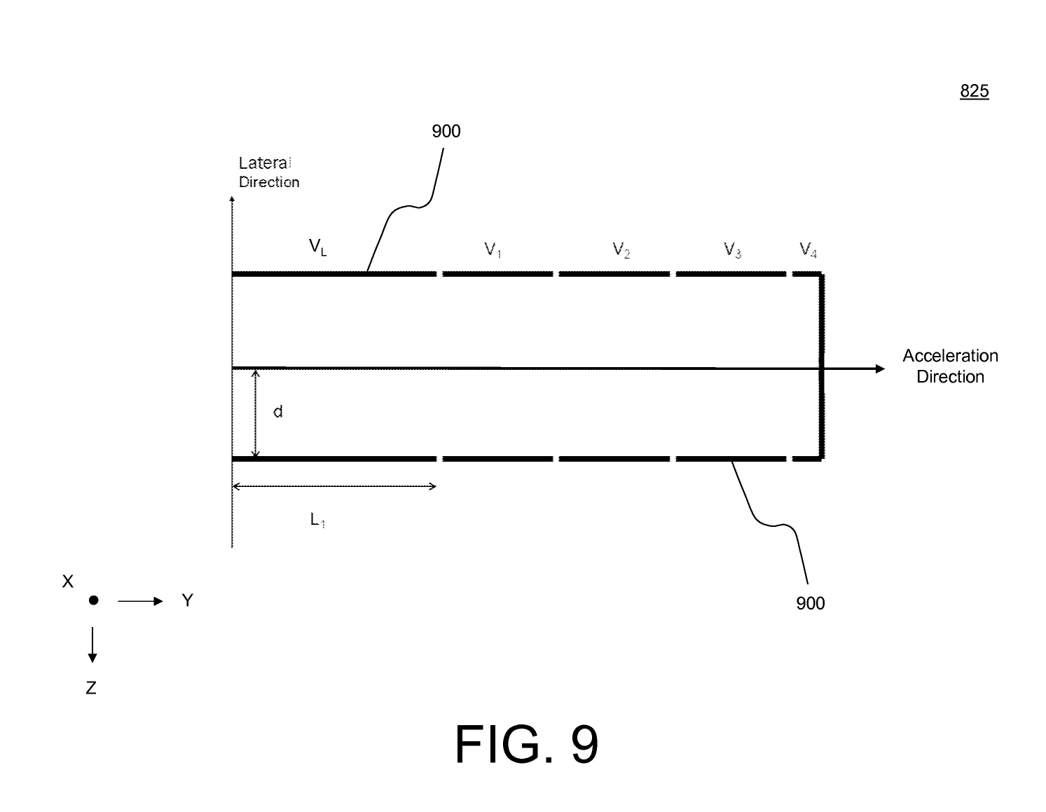

FIG. 9 shows a cross-section of one mirror unit cell 825 in the lateral-acceleration (YZ) plane, taken at the mid-point of the unit cell. FIG. 9 shows that mirror unit cell 825 includes a plurality of electrodes 900 held at different voltage levels (V₁, V₂, V₃, V₄, etc.).

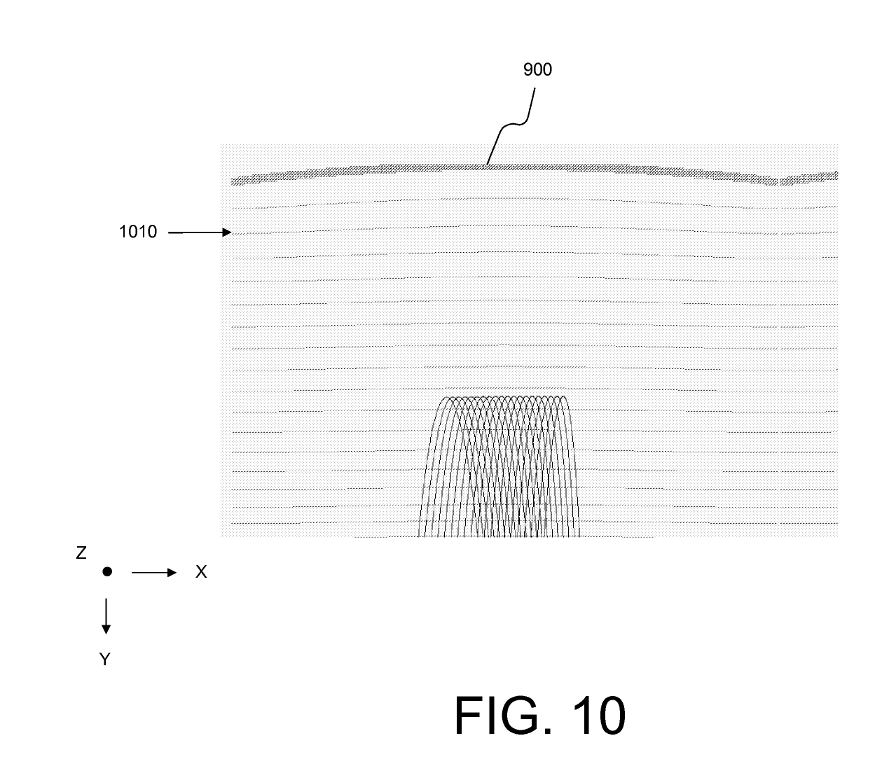

FIG. 10 shows the isopotential lines of the mirror potential at a cross-sectional plane taken along the drift-acceleration (XY) plane, at the mid-point of mirror 820. The only electrode 900 visible in FIG. 10 is the back wall of the mirror. Near the back wall, the isopotential lines match the curvature of the back electrode. The electrostatic potential and ion trajectories are computed using SIMION® 8.0 ion and electron optics simulation software. The electrostatic potential is solved in three dimensions with reflective symmetry along the drift-acceleration (XY) and lateral-acceleration (YZ) planes. The departure from perfect cylindrical symmetry caused by adjacent mirror unit cells 825 is evident, particularly near the border between mirror unit cells 825. Nevertheless, by proper choice of cell dimensions and by not vastly exceeding the mirror focal power required to guide the primary beam of a given kinetic energy spread, the field penetration from adjacent mirror unit cells 825 can be made minimally disruptive even for wide beams.

In the embodiment shown in FIG. 8, detector 860 is located at the spatial focal point, but it need not be located there. Detector 860 can be displaced in the longitudinal (Y) direction in order to allow the free space time-delay to correct for the mirror time-advance, either partially or fully.

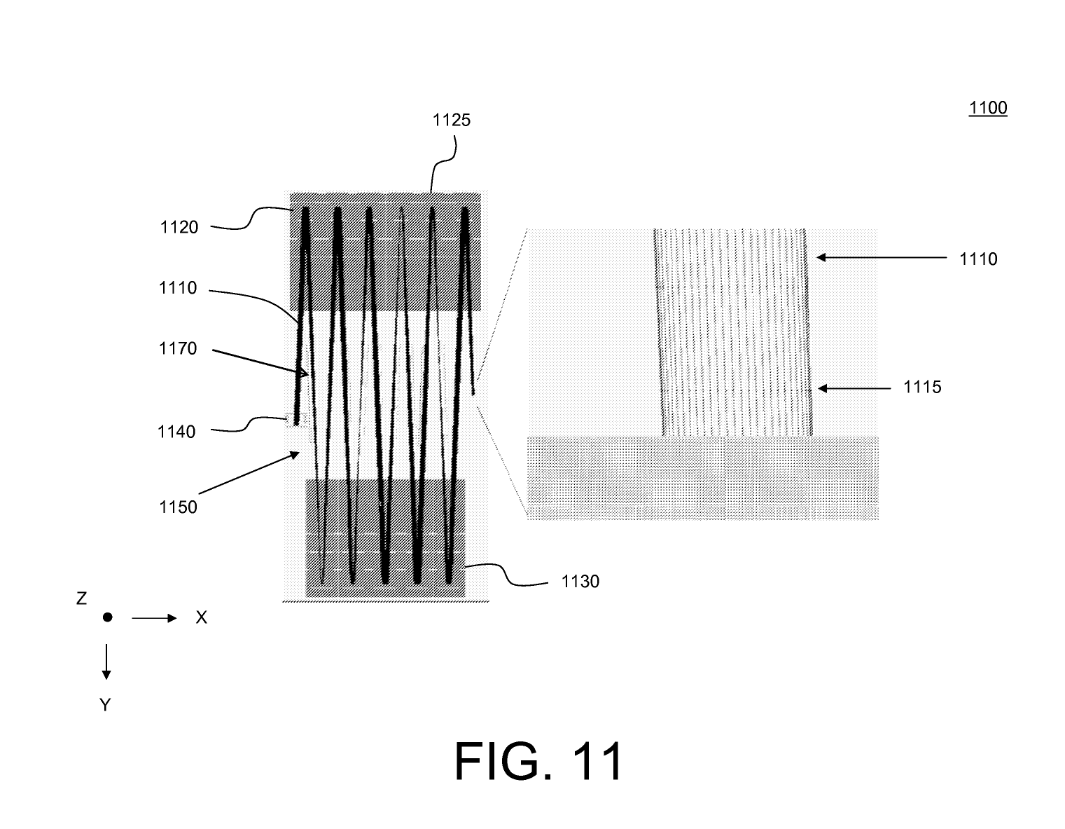

FIG. 11 shows another embodiment of a multi-reflecting time-of-flight mass spectrometer (MR-TOFMS) 1100 which uses both curved ion mirrors 1120 and 1130, and lenses (e.g., Einzel lenses) 1170 to realize drift (X) direction refocusing. In TOFMS 1100, curved ion mirror 1120 includes six mirror unit cells 1125, while curved ion mirror 1130 includes only five mirror unit cells. Lenses 1170 are placed intermediate to curved ion mirrors 1120 and 1130 and are arranged periodically along the mid-plane of the overall structure in the drift space 1150. As before, ion beam 1110 drifts into ion accelerator 1140. Upon application of a high voltage pulse, ions travel predominantly towards mirror 1120 with a slight angle (the natural angle) from the acceleration (Y) direction. After multiple (e.g., eleven) reflections through lenses 1170 and drift space 1150, the ions reach ion detector 1160 at the right.

The inset of FIG. 11 shows the shape of the beam front 1115 of the ion beam 1110 just before hitting the ion detector (not shown in FIG. 11). All of the intermediate lenses 1170 have the same voltage and are periodically spaced to match the drift (X) direction displacement of ion beam 1110 over each reflection. Lenses 1170 are rotated in alternating directions by the natural angle so that each lens 1170 is symmetrically oriented about ion beam 1110. By optimally choosing the lens voltage, and hence the focal length, the second-order time aberration with respect to drift (X) direction can be minimized. Beneficially, the curvature of curved ion mirrors 1120 & 1130 may be different than that of curved ion mirrors 820 & 830 of TOFMS 800 since the lenses provide an additional degree of freedom.

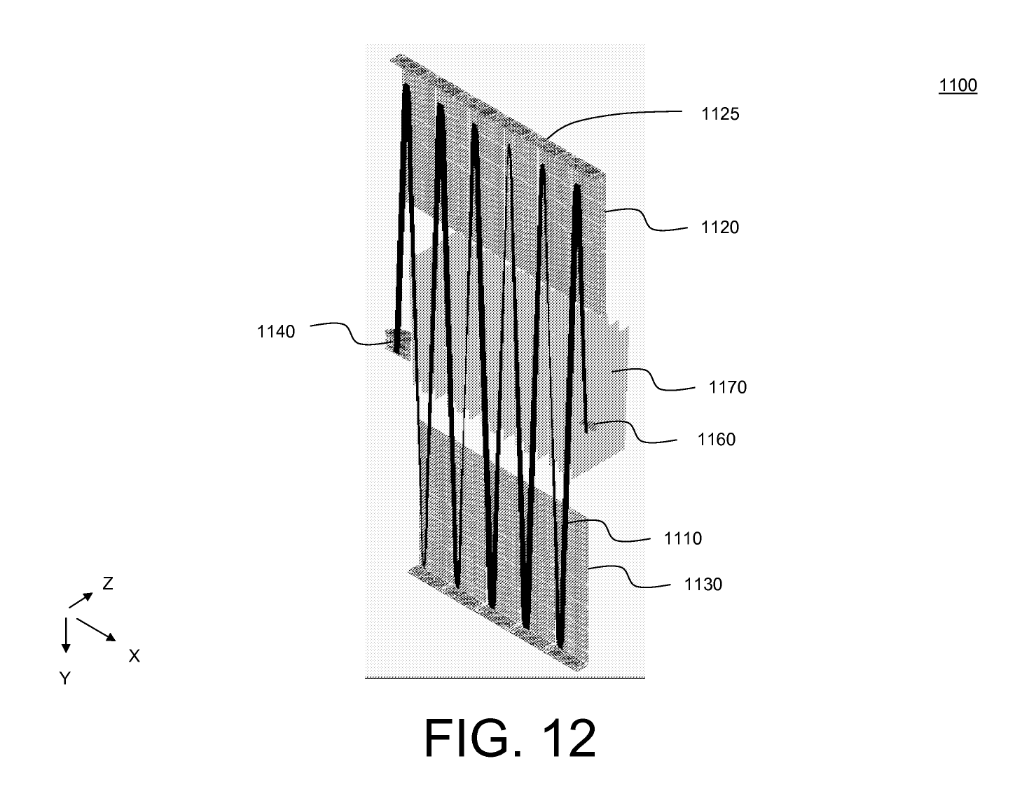

FIG. 12 shows a three-dimensional view of TOFMS 1100 using lenses 1170 and curved mirrors 1120 and 1130 to realize transverse focusing in the drift (X) direction.

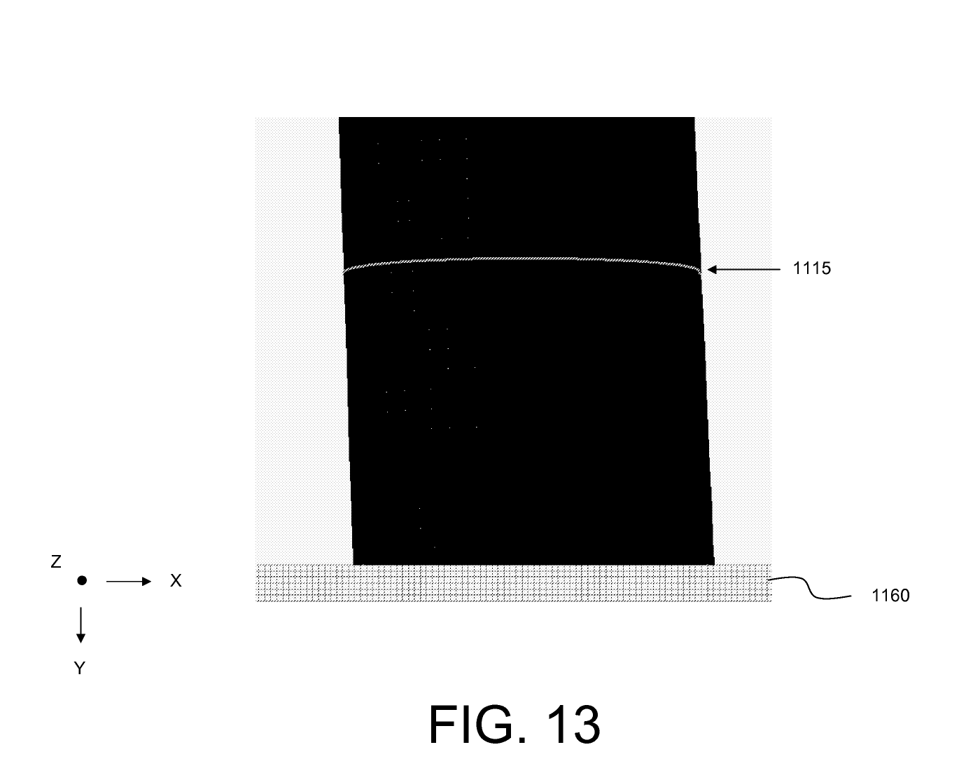

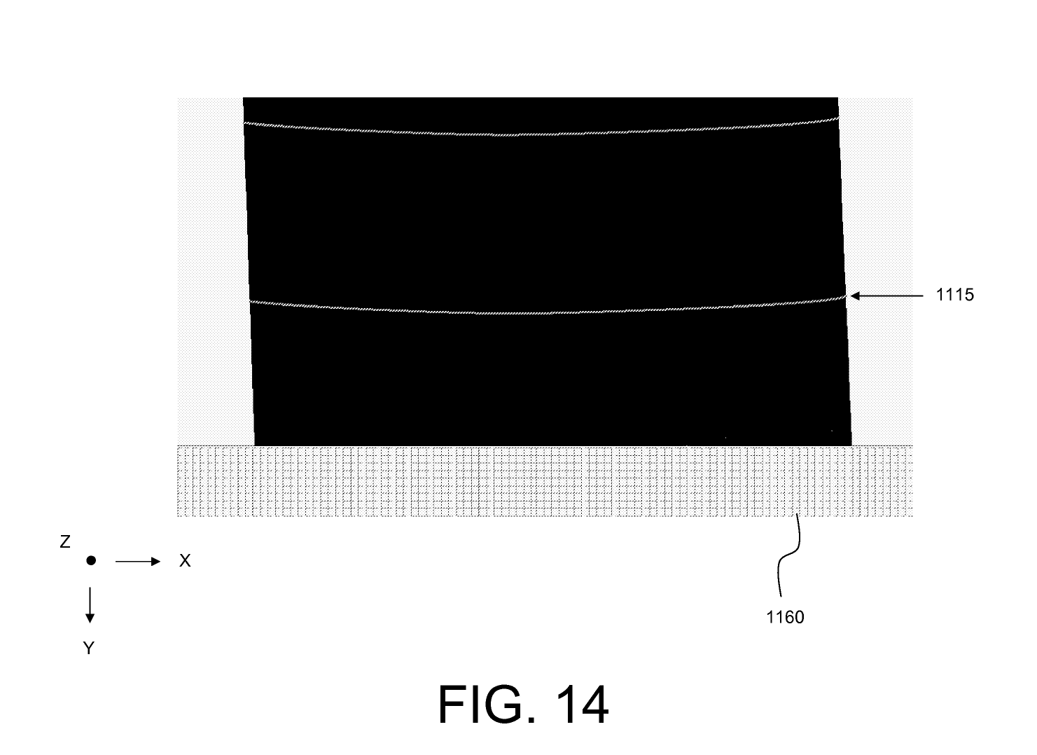

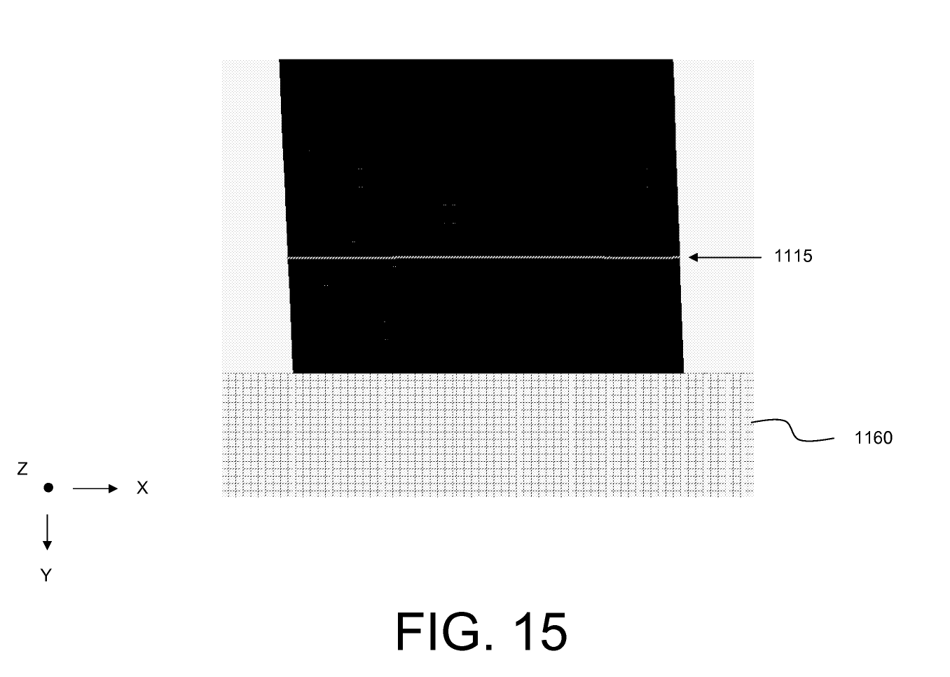

FIGS. 13-15 show close-ups of the beam front 1115 just before hitting detector 1160 for three different settings of the voltage applied to lenses 1170. FIG. 13 shows the shape of beam front 1115 when the lens voltage is set to the same value as the surrounding electrodes, effectively turning off lenses 1170. In this case, curved ion mirrors 1120 and 1130 dominate the drift direction focusing and beam front 1115 is concave, resembling the overall curvature of the isopotential lines of curved ion mirrors 1120/1130. FIG. 14 shows the beam front 1115 when the lens voltage is set to twice its optimal value and the focusing power of lenses 1170 is too high. In this case, lenses 1170 dominate the drift direction focusing, making beam front 1115 convex, no longer resembling the isopotential lines of curved ion mirrors 1120/1130. FIG. 15 shows beam front 1115 just before hitting detector 1160 when the lens voltage is set to its optimal value and beam front 1115 is flat and parallel to detector 1160. The flat beam front 1115 indicates that the drift direction focusing is optimally distributed between curved ion mirrors 1120/1130 and lenses 1170, and the second order time aberration with respect to drift (X) direction deviation is compensated.

Examples of specific mechanical, electrical, and performance details for TOFMS 1100 are now described for illustration purposes.

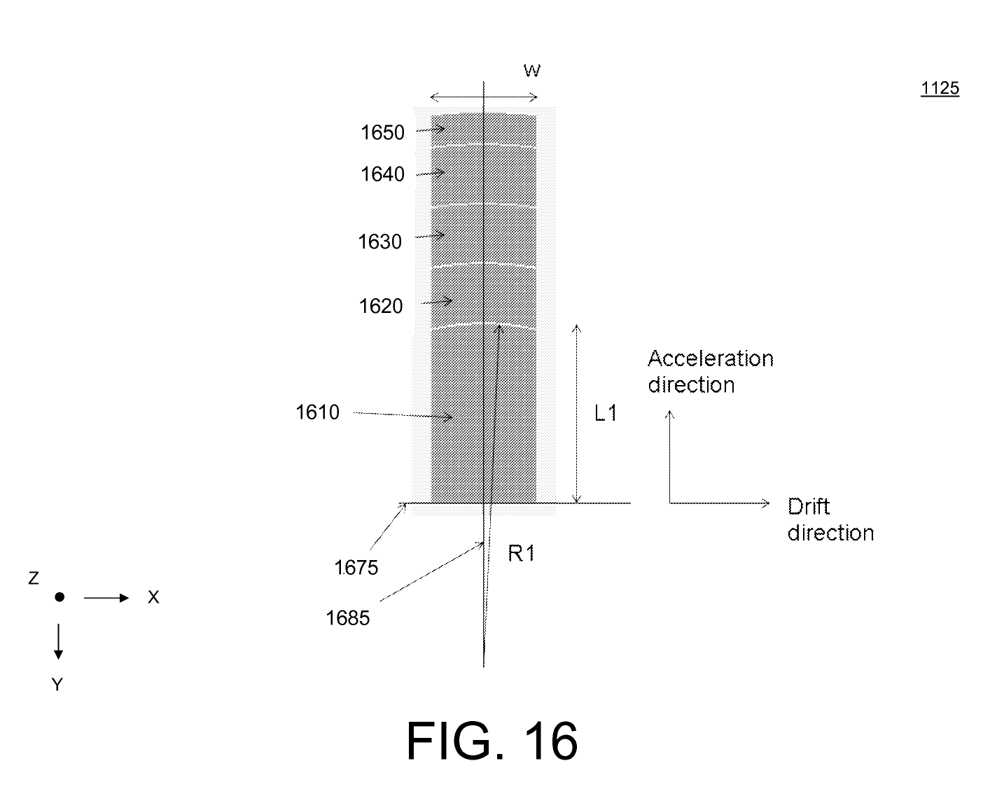

FIG. 16 shows a detailed mechanical drawing of one mirror unit cell 1125. Mirror unit cell 1125 consists of five metal electrodes (see FIG. 9), a liner 1610 and four arc shaped mirror electrodes 1620, 1630, 1640 and 1650. The liner voltage sets the electrostatic potential far from the mirror region and the four mirror electrodes 1620, 1630, 1640 and 1650 define the reflecting potential. The width of mirror unit cell 1125 in the drift (X) direction is denoted w. In one example embodiment, w=80.0 mm. The cylindrical symmetry of the electrodes means that all of the arcs which define the electrode shapes are concentric. Mirror electrodes 1620, 1630, 1640 and 1650 are fully described by specifying the radius of curvature of each of the arcs which separates each pair of adjacent electrodes. Each of these imaginary arcs is drawn at the half-way point between adjacent electrodes. In one example embodiment, the gap separating all pairs of adjacent electrodes is 1 mm. The radius of curvature of the arc defining the mid-point between liner 1610 and first mirror electrode 1620 is denoted R1 and is beneficially a finite value (i.e., non-planar). In one example embodiment: R1=720 mm; the arcs defining the midpoint between electrodes 1620 and 1630, 1630 and 1640, and 1640 and 1650 have respective radii of curvature of 765 mm, 810 mm, and 855 mm; and the arc which forms the back edge of electrode 1650 has a radius of curvature of 877.5 mm. Electrode 1650 has a back wall curved along the same radius of curvature and is shown in FIGS. 9 and 10. The distance in the acceleration (Y) direction between the time-focus plane and the mid-point between liner 1610 and electrode 1620 is denoted by L1. In one example embodiment, L1=343.5 mm. This distance is measured along an imaginary line 1685 down the middle of the structure, a distance of W/2 from each side. Referring to FIG. 9, the lateral (Z direction) half-width of the mirror structure is denoted d. In one example embodiment, 2*d=56.0 mm.

A total of eleven mirror unit cells 1125 are assembled to form TOFMS 1100. Each of the unit cells 1125 abuts its neighbors with no gap between them. Liner 1610 of each mirror unit cell 1125 abuts the time-focus plane 1675. TOFMS 1100 does not have reflective symmetry about the time-focus plane 1675 because the lower mirror 1130 is displaced in the drift direction relative to upper mirror 1120. In one example embodiment, the displacement is 40.0 mm. This insures that the trajectories are periodic mirror each unit cell 1125, presuming the natural angle of TOFMS 1125 is 2.25 degrees. In TOFMS 1100, detector 1160 is displaced in the drift direction from where the beam first intersects time-focus plane 1675. In one example embodiment, the displacement is 440 mm. Beneficially, the active surface of detector 1160 is plane-parallel to time focus plane 1675.

The ten lenses 1170 are periodically spaced along the drift (X) direction. In one example embodiment, the periodic spacing is 40.0 mm. The rotation angle about the lateral axis of each lens 1170 alternates. In one example embodiment, the rotation angle is either plus 2.25 degrees or minus 2.25 degrees so that each lens 1170 is oriented symmetrically about ion beam 1110 passing through it. As shown in FIG. 6, each lens 1170 has two planar electrodes and four-fold reflective symmetry. In one example embodiment, the total length of each lens 1170 is 250 mm, the center lens electrode 602 (see FIG. 6) is 22.5 mm long, the gaps separating the electrodes 602/604a/604b (see FIG. 6) are 2.5 mm, and the inner width of each lens 1170 is 23 mm. The outer electrodes 604a/604b (see FIG. 6) of each lens 1170 are electrically connected to liners 1610 of the mirror sets 1120/1130. The relative voltage between center lens electrode 602 and liner 1610 will be referred to as the lens voltage.

Beneficially, the voltages on mirrors 1120/1130 and lenses 1170 are optimized for maximum mass resolution using a simple algorithm.

For example, consider a case where the initial ion beam has a mean kinetic energy of 10 eV and a kinetic energy spread of 2 eV, and the drift direction width of the beam is 18 mm. Also consider that, after acceleration, the ion beam has a mean kinetic energy of 6548.5 eV and FWHM kinetic energy spread of 369 eV, the lateral width of the beam is 14 mm, and the lateral velocity spread causes an angular spread of 0.25 degrees. Also assume that the ion accelerator is designed so that the first time focus of the beam falls on the time-focus plane.

In that case, beneficially the voltages may be as follows. The liner voltage is VL=−5923.54 volts, and remaining mirror electrode voltages are: V1=−19208.2 volts, V2=−4642.25 volts, V3=373.413 volts, and V4=2647.33 volts. For an ion mass of 1000 amu, in this example the flight time is 325 microseconds and the aberration induced time spread is 1.29 ns. With the above parameters the computed resolution is 125,000.

It should be understood that various other embodiments may be constructed with different dimensions and voltages from that described above. The numerical values described above are provided to illustrate in detail one concrete embodiment, but should not be construed as limiting the scope of this disclosure or the claims that follow.

Many other forms of the curved ion mirror electrode structure can be built to create the concave electrostatic potential capable of transverse mirror focusing similar in function to that described above with respect to TOFMS 800 illustrated in FIG. 8 and TOFMS 1100 illustrated in FIG. 11.

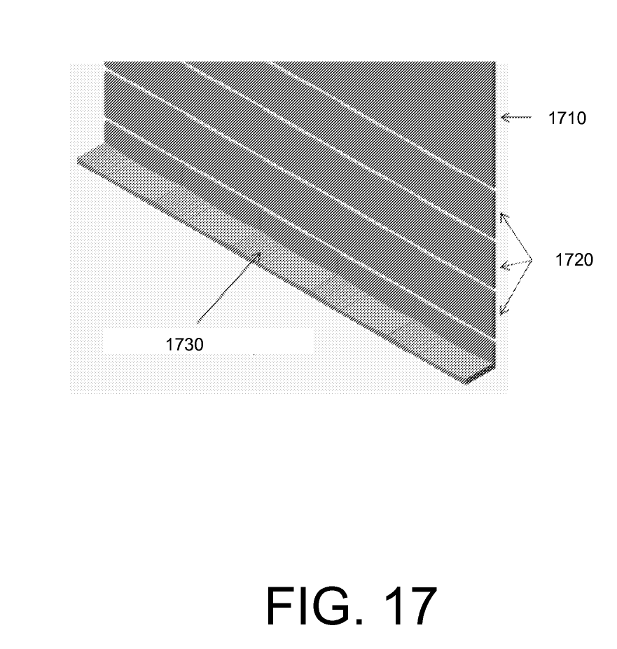

FIG. 17 shows one embodiment of a curved ion mirror 1700 in which liner 1710 and all mirror elements 1720 are straight, except for one element at the back, the so-called backplate electrode 1730, which is curved.

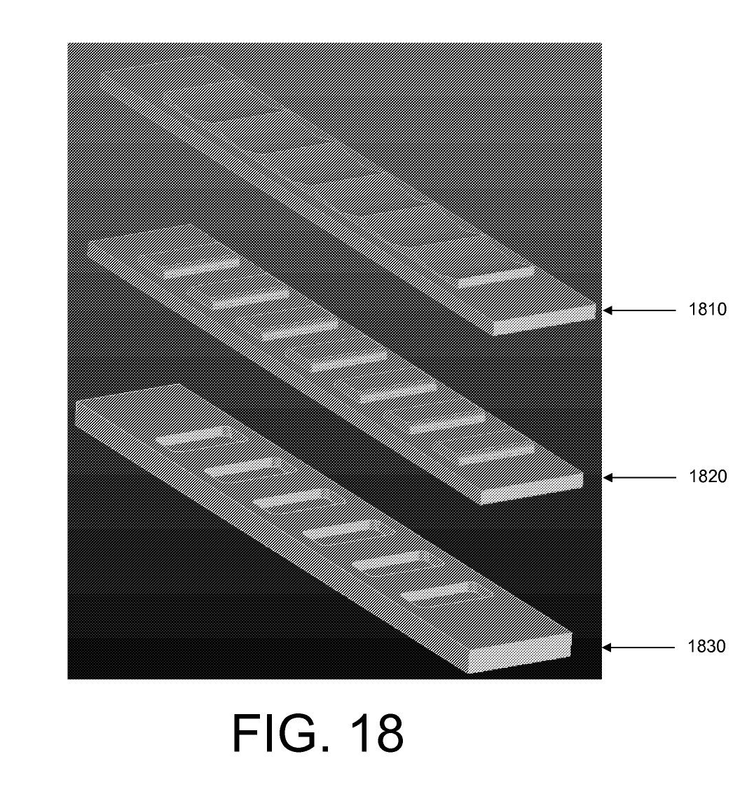

FIG. 18 shows three embodiments of mirror elements for creating concave mirror potentials capable of reflective transverse focusing. In particular, FIG. 18 illustrates three different backplate electrode designs.

The upper-most backplate electrode 1810 of FIG. 18 is the curved backplate electrode shown as part of the entire assembly in FIG. 17.

The middle backplate electrode 1820 of FIG. 18 has protrusions into the mirror inner cavity. The protrusion distance, radius value, and electrode separation are chosen to create a predominately curved electrostatic potential at the mirror back. In another embodiment, not shown, the protrusions are electrically isolated from the rest of the backplate electrode so that the electrostatic potential curvature is adjusted by varying the voltage applied to the protrusions. The protrusions could also be electrically isolated segments co-planar with the rest of the backplate. The lengths of the sections, number of sections, and voltages on each section are chosen so to create a predominately concave electrostatic potential capable of transverse focusing.

The lower-most backplate electrode 1830 of FIG. 18 illustrates an example where the curved electrostatic potential is created by indentations or recessions into backplate electrode 1830. The shape and depth of the indentations determinate the degree to which the electrostatic potential is curved.

Embodiments disclosed herein provide a means for drift direction refocusing distinct from, and in certain aspects superior to, prior art devices with respect to structure, simplicity of construction and operation, and degree of aberration compensation which leads to higher mass resolving power and more sensitive instruments. Drift direction focusing curved mirror potentials offers distinct advantages over prior methods which utilize lenses rather than mirrors. Because focusing on both transverse axes is accomplished by the ion mirror, some embodiments have no lens elements for drift direction focusing, eliminating some instrument complexity. Operational simplicity derives from the fact that the focal length of the curved mirror is approximately constant with respect to mirror electrode voltages, allowing the mirror voltages to be optimized without causing a departure from the advantageous drift-direction spatial focal length.

Additional advantages of some embodiments are apparent when time-of-flight aberrations are considered. As discussed above, ions with greater transverse deviation from the optic axis leave the ion mirror before the optical ray. Ions on the outer edges of the ion packets spend less time in the mirror than the optical ray by an amount proportional to the square of their initial displacement from optical ray. This time-advance in the mirror can be used to compensate two important sources of time-delay caused by transverse deviation: the time-delay which a focused ion experiences as it travels in the field-free regions and, secondly, the time delay a focused ion experiences after having gone through a transmissive lens. By placing the ion detector at a particularly advantageous distance from the curved mirror, which is not necessarily the spatial focal point, the mirror time advance can cancel the free-space propagation delay to second order. When a combination of curved-mirrors and lenses are used for drift direction focusing, the net transverse time-of-flight aberration can be compensated to second order. The second-order drift direction compensation scheme disclosed here can be used to increase mass resolution, analyte sensitivity, or both.

While example embodiments are disclosed herein, one of ordinary skill in the art appreciates that many variations that are in accordance with the present teachings are possible and remain within the scope of the appended claims. The invention therefore is not to be restricted except within the scope of the appended claims.

1. A multi-reflecting time-of-flight mass spectrometer (MR-TOFMS) comprising:
an ion accelerator adapted to receive ions travelling in a drift direction and to accelerate the ions in an acceleration direction orthogonal to the drift direction;
an ion detector downstream of the ion accelerator with respect to the drift direction; and
an ion mirror assembly intermediate the ion accelerator and the ion detector, the ion mirror assembly comprising at least a first ion mirror and a second ion mirror spaced apart from each other in the acceleration direction,
wherein the ion accelerator, ion detector, and ion mirror assembly are arranged to provide a folded ion path between the ion accelerator and the ion detector for separating the ions in time of arrival according to their mass-to-charge ratio so that a flight time of the ions is substantially independent of ion energy, and
wherein at least one of the first and second ion mirrors applies a curved electrostatic potential to the ions in both the drift direction and a lateral direction orthogonal to both the drift direction and the acceleration direction.

2. The MR-TOFMS of claim 1, wherein the ion mirrors each apply to the ions a cylindrically symmetric electrostatic potential with concave shape.

3. The MR-TOFMS of claim 1, wherein the detector is located at a position that is separated and spaced apart from a spatial focal point of the mirror assembly.

4. The MR-TOFMS of claim 1, wherein the ion mirrors each include a plurality of electrodes, the plurality of electrodes being curved along concentric arcs to create concave isopotential surfaces.

5. The MR-TOFMS of claim 1, wherein the ion mirrors each include a plurality of electrodes, wherein at least one of the electrodes is not curved.

6. The MR-TOFMS of claim 1, wherein none of the electrodes is curved.

7. The MR-TOFMS of claim 1, wherein each mirror includes a plurality of substantially identical mirror unit cells disposed adjacent each other.

8. The MR-TOFMS of claim 1, wherein each mirror includes a backplate electrode having a plurality of indentations therein.

9. The MR-TOFMS of claim 1, wherein each mirror includes a backplate electrode having a plurality of protrusions associated therewith.

10. A multi-reflecting time-of-flight mass spectrometer (MR-TOFMS) comprising:
an ion accelerator adapted to receive ions travelling in a drift direction and to accelerate the ions in an acceleration direction orthogonal to the drift direction;
an ion detector downstream of the ion accelerator with respect to the drift direction;
an ion mirror assembly intermediate the ion accelerator and the ion detector, the ion mirror assembly comprising at least a first ion mirror and a second ion mirror spaced apart from each other in the acceleration direction; and
an ion lens assembly intermediate the first and second ion mirrors,
wherein the ion accelerator, ion detector, ion lens assembly, and ion mirror assembly are arranged to provide a folded ion path between the ion accelerator and the ion receiver for separating the ions in time of arrival according to their mass-to-charge ratio so that a flight time of the ions is substantially independent of ion energy, and
wherein at least one of the first and second ion mirrors applies a curved electrostatic potential to the ions in both the drift direction and a lateral direction orthogonal to both the drift direction and the acceleration direction, and
wherein voltages are applied to the ion mirror assembly and the ion lens assembly to at least partially compensate a second order time aberration with respect to drift direction deviation among the ions.

11. The MR-TOFMS of claim 10, wherein the ion mirrors each apply to the ions a cylindrically symmetric electrostatic potential with concave shape.

12. The MR-TOFMS of claim 10, wherein the detector is located at a position that is separated and spaced apart from a spatial focal point of the mirror assembly.

13. The MR-TOFMS of claim 10, wherein the ion mirrors each include a plurality of electrodes, the plurality of electrodes being curved along concentric arcs to create concave isopotential surfaces.

14. The MR-TOFMS of claim 10, wherein the ion mirrors each include a plurality of electrodes, wherein at least one of the electrodes is not curved.

15. The MR-TOFMS of claim 10, wherein none of the electrodes is curved.

16. The MR-TOFMS of claim 10, wherein each mirror includes a plurality of substantially identical mirror unit cells disposed adjacent each other.

17. The MR-TOFMS of claim 10, wherein each mirror includes a backplate electrode having a plurality of indentations therein.

18. The MR-TOFMS of claim 10, wherein each mirror includes a backplate electrode having a plurality of protrusions associated therewith.

19. A method of multi-reflecting time-of-flight mass spectrometry, comprising:
receiving ions travelling in a drift direction and accelerating the ions in an acceleration direction orthogonal to the drift direction;
providing a folded ion path between the ion accelerator and the ion receiver for separating the ions in time of arrival according to their mass-to-charge ratio so that a flight time of the ions is substantially independent of ion energy; and
detecting a time of arrival of the ions at a detector downstream of the ion accelerator with respect to the drift direction,
wherein providing the folded ion path includes reflecting the ions from first and second ion mirrors, each of the first and second ion mirrors applying a curved electrostatic potential to the ions in both the drift direction and a lateral direction orthogonal to both the drift direction and the acceleration direction.

20. The method of claim 19, wherein providing the folded ion path includes passing the ions through a lens assembly intermediate the first and second ion mirrors.
